(19) United States
(12) Patent Application Publication
(10) Pub. No.: US 2022/0051834 A1
(43) Pub. Date: Feb. 17, 2022

(54) METHOD FOR PRODUCING A LAYER STRUCTURE USING A PASTE ON THE BASIS OFA RESISTIVE ALLOY

(71) Applicant: Isabellenhütte Heusler GmbH & Co. KG, Dillenburg (DE)

(72) Inventors: Jochen Langer, Mörlenbach (DE); Melanie Bawohl, Hanau (DE); Christina Modes, Hattersheim (DE); Steffen Burk, Gladenbach (DE); Jan Marien, Herborn (DE); Paul Kalemba, Herborn (DE); Anja Desch, Bad Soden-Salmünster (DE); Roland Reul, Nidderau (DE); Jessica Reitz, Gelnhausen (DE)

(73) Assignee: ISABELLENHÜTTE HEUSLER GMBH & CO. KG., DILLENBURG (DE)

(21) Appl. No.: 17/388,676

(22) Filed: Jul. 29, 2021

Related U.S. Application Data
(62) Division of application No. 16/340,611, filed on Apr. 9, 2019, now abandoned.

(30) Foreign Application Priority Data
Oct. 11, 2016 (EP) 16193341.1

(51) Int. Cl. H01C 17/065; C22C 9/05; C22C 9/06; C22C 19/05; H01C 7/00

(52) U.S. Cl. CPC H01C 17/06553; C22C 9/05; C22C 9/06; H01C 17/06593; H01C 7/003; H01C 17/06526; H01C 17/06533; C22C 19/058

(57) ABSTRACT

The present invention concerns a layer structure comprising: a substrate having a glass or ceramic surface, a layer A at least partially covering the glass or ceramic surface of the substrate, wherein layer A comprises a glass in which at least two mutually different elements are contained as oxides, and a layer B at least partially covering the layer A. Layer B comprises: a resistance alloy having a temperature coefficient of electrical resistance less than 150 ppm/K, and optionally a glass containing at least two mutually different elements as oxides. Layer B contains not more than 20 weight percent of glass based on the total weight of layer B.

The invention concerns a method for producing a layer structure on a substrate using a paste based on a resistance alloy, as well as the resulting layer structure and its use.

Especially for the production of precision resistors alloys with a low temperature coefficient of electrical resistance (TCR) are used. Such alloys with a low TCR value are called resistance alloys within the scope of the invention. A typical resistance alloy with a low TCR value is e.g. ISOTAN® (also known as CuNi44, material no. 2.0842). To produce precision resistors, the alloy layers are applied to a substrate with a surface of a glass or ceramic material. Resistance alloys in the form of foils or sheets are usually bonded by roll cladding or lamination to substrate materials commonly used in electrical engineering. There is a need to apply resistance alloys as pastes to substrate materials using simple printing techniques, in particular screen printing or stencil printing, as this enables more flexible layer geometries. For this purpose it is necessary to provide resistance alloys in the form of printable pastes which can be burned in after application to the substrate. Such pastes consist at least of a powder of the resistance alloy concerned and an organic medium. During burning, the components of the organic medium volatilize and the molten or sintered powder of the resistance alloy remains. A wide range of organic media is available in which powders of these resistance alloys can be formulated and which basically guarantee printability. However, it has turned out that pastes consisting only of resistance alloy powder and organic medium show only low adhesion on the ceramic substrates used after burning. An improved adhesion of printed resistance alloys on glass or ceramic surfaces can basically be achieved by adding a glass frit to a resistance alloy paste. Layer structures consisting of a ceramic substrate and a glassy resistance alloy paste, or the resulting layer structures after burning, are state of the art. EP 0 829 886 A2, for example, teaches a resistance alloy paste containing glass frit, which is applied to an Al₂O₃ substrate. However, if a glass frit is added to the resistance alloy paste, this has the disadvantage that the TCR value of the layer formed after burning can differ from the TCR value of the bulk resistance alloy, so that the advantageous electrical properties of the resistance alloy cannot be exploited in the composite formed in this way.

The task underlying this invention is to provide a method for the production of resistance alloy layers on glass or ceramic surfaces by which resistance alloys can be applied by printing a paste and allow strong adhesion of the resistance alloys to the ceramic substrate without affecting the electrical properties of the resistance alloys in the layer structure produced. Furthermore, the task is to provide a layer structure in which the resistance alloy is mechanically stably bonded to the glass or ceramic surface of a substrate after burning.

These tasks are solved by a method for producing a layer structure comprising the successive steps:
a. Providing a substrate having a glass or ceramic surface,
b. Applying a paste A to at least a portion of the glass or ceramic surface of the substrate to obtain a layer of paste A, wherein paste A contains the following constituents:
   I. a glass frit containing at least two mutually different elements as oxides and having a transformation temperature Tg in the range of 600 to 750° C., and
   II. an organic medium,
c. Drying and, if necessary, burning of the layer of paste A
d. Applying a paste B to at least part of the layer from step c. to obtain a layer of paste B, wherein paste B contains the following constituents:
   I. A resistance alloy powder having an electrical resistance temperature coefficient of less than 150 ppm/K
   II. an organic medium,
   III. 0-15 weight percent glass frit, based on the total weight of paste B, and
e. Burning and optional drying of the layers of paste B before burning.

The person skilled in the art knows from the previous formulation that the order of the steps must be adhered to, although it cannot be ruled out that further steps can optionally be carried out between the mentioned steps as long as the order is not changed.

It was found that the method according to the invention can be used to produce a layer structure with improved mechanical stability, in particular better long-term stability, without essentially altering the TCR of the resistance alloy.

Surprisingly, it was found that particularly good layer structures can be produced if a paste A is applied to the glass or ceramic surface of a substrate before the paste B is applied and, at the same time, the proportion by weight of glass frit in paste B is adjusted so that the paste B does not contain more than 15% by weight.

In step a), a substrate with a glass or ceramic surface is provided. The substrate thus has a surface comprising a ceramic or a glass, wherein the ceramic material of the surface may preferably be selected from the group consisting of oxide ceramics, nitride ceramics and carbide ceramics. Examples of suitable ceramics are forsterite, mullite, steatite, aluminium oxide, aluminium nitride, silicon carbide and hard porcelain. In particular, the ceramic surface contains aluminium oxide or consists of aluminium oxide. The glass of the glass surface is preferably a silicate glass.

In step b), a paste A is applied to at least part of the glass or ceramic surface of the substrate. It can be applied by screen printing, stencil printing, doctoring or spraying. A layer of paste A is obtained by the application. Paste A contains at least one glass frit and one organic medium or consists of at least one glass frit and one organic medium. Paste A preferably contains 50-90% by weight glass frit and 10-50% by weight organic medium, based on the total weight of Paste A.

The glass frit of paste A contains at least two different elements as oxides. These elements may be selected from the group consisting of Li, Na, K, Ca, Mg, Sr, Ba, B, Al, Si, Sn, Pb, P, Sb, Bi, Te, La, Ti, Zr, V, Nb, Mn, Fe, Co, Ni, Cu, Ag, Zn, and Cd. The glass frit can be made of oxides, fluorides or other salts (e.g. carbonates, nitrates, phosphates) of these elements. Examples of starting compounds for glass frit production may be selected from the group consisting of B₂O₃, H₃BO₃, Al₂O₃, SiO₂, PbO, P₂O₅, Pb₃O₄, PbF₂, MgO, MgCO₃, CaO, CaCO₃, SrO, SrCO₃, BaO, BaCO₃, Ba(NO₃)₂, Na₂B₄O₇, ZnO, ZnF₂, Bi₂O₃, Li₂O, Li₂CO₃, Na₂O, NaCO₃, NaF, K₂O, K₂CO₃, KF, TiO₂, Nb₂O₅, Fe₂O₃, ZrO₂ CuO, Cu₂O, MnO, MnO₂, Mn₃O₄, CdO, SnO₂, TeO₂, Sb₂O₃, Co₃O₄, Co₂O₃, CoO, La₂O₃, Ag₂O, NiO, V₂O₅, Li₃PO₄, Na₃PO₄, K₃PO₄, Ca₃(PO₄)₂, Mg₃(PO₄)₂, Sr₃(PO₄)₂, Ba₃(PO₄)₂ and complex minerals, such as e.g. colemanite and dolomite.

The transformation temperature Tg of the glass frit of the paste A is in the range of 600-750° C., particularly in the range of 690-740° C. The transformation temperature Tg can be determined for the purpose of the invention according to DIN ISO 7884-8:1998-02.

The glass frit contained in paste A preferably comprises silicon, aluminium, boron and at least one alkaline earth metal as oxide. The alkaline earth metal calcium is particularly preferred.

In order to achieve a particularly good adhesion, the glass frit can be produced in a preferred embodiment from:

a. 25-55 weight percent silicon oxide,

b. 20-45 weight percent calcium carbonate,

c. 10-30 weight percent of aluminium oxide; and

d. 1-10 weight percent boron oxide.

The organic medium may contain at least one organic solvent and at least one binder. The organic solvent may be selected from the group consisting of texanol, terpineol and other high boiling organic solvents having a boiling point of at least 140° C. The binder can be selected from acrylate resins, ethyl celluloses and other polymers such as butyrals. Optionally the organic medium of the paste A can contain further components, which can be selected from the group consisting of thixotropic agents, stabilizers and emulsifiers. The addition of these components can, for example, improve the printability or storage stability of pastes.

In step c), a drying step is carried out and, if necessary, the layer of paste A is burned. Drying can take place at temperatures in the range of 20-180° C., particularly in the range of 120-180° C., e.g. in a drying cabinet. By drying, the layer of paste A can be fixed on the substrate. The dried layer of paste A can already be so mechanically robust that a layer of paste B can be applied directly.

The layer of paste A can optionally be burned after drying. The burning can be carried out at temperatures in the range of 750-950° C. The layer of paste A is preferably burned in such a way that the organic medium is essentially removed and the glass frit is sintered together as homogeneously as possible. The burned layer of paste A contains at least one glass or consists of one glass. The burned layer of paste A can also be called layer A. Burning can take place either under atmospheric conditions or under inert gas conditions (e.g. N₂ atmosphere). In a preferred embodiment of the invention, the layer of paste A is first dried in step c) and then burned. If the layer of paste A in step c) is already burned, it may be better to apply paste B in the following step d).

In step d), paste B is applied to at least a part of the layer from step c. while retaining a layer of paste B. The paste B is then applied to at least a part of the layer from step c. The paste B of this invention contains at least one resistance alloy powder and one organic medium. Optionally, paste B may also contain a glass frit. However, it may also be preferred that paste B does not contain glass frit. A glass-free paste B can have the advantage that the electrical properties of the resistance alloy, in particular the TCR value, are not negatively influenced by the presence of glass.

In order to further improve the adhesion of layer B to layer A in the finished layer structure, it may also be preferable for paste B to contain a glass frit. However, paste B does not contain more than 15 weight percent, preferably not more than 12 weight percent glass frit, based on the total weight of paste B. As can be seen in Table 5, a glass frit in paste B can improve the adhesion of the layer structure during frequent temperature changes (T-shock storage). Paste B preferably contains at least 3 percent by weight glass frit, in particular at least 5 percent by weight based on the total weight of paste B. Preferably, paste B may contain glass frit in an amount of 3-15 weight percent, more preferred glass frit in an amount of 5-12 weight percent, based on the total weight of Paste B. The content of resistance alloy in paste B may preferably be in the range of 60-98 percent by weight and the content of organic medium may be in the range of 2-40 percent by weight, in particular in the range of 2-37 percent by weight, based on the total weight of paste B in each case.

The resistance alloys used for the powder have a temperature coefficient of electrical resistance of less than 150 ppm/K, preferably less than 100 ppm/K and particularly preferred less than 50 ppm/K. The temperature coefficient of electrical resistance indicated in the invention refers to the measurement of the bulk alloy and can be determined in the invention on a wire or foil of the corresponding alloy in accordance with DIN EN 60115-1:2016-03 (with drying method I).

For example, the resistance alloy may contain elements selected from the group consisting of chromium, aluminium, silicon, manganese, iron, nickel and copper. The resistance alloy may preferably be selected from the group consisting of CuNi, CuNiMn, CuSnMn and NiCuAlSiMnFe. In a particularly preferred embodiment, the resistance alloy can be selected from the group consisting of the alloys:

I.

| | | |
|---|---|---|
| Copper | 53.0-57.0 | weight percent |
| Nickel | 42.0-46.0 | weight percent |
| Manganese | 0.5-1.2 | weight percent |
| Other elements | ≤10000 | weight ppm |

II.

| | | |
|---|---|---|
| Copper | 83.0-89.0 | weight percent |
| Nickel | 1-3 | weight percent |
| Manganese | 10.0-14.0 | weight percent |
| Other elements | ≤10000 | weight ppm |

III.

| | | |
|---|---|---|
| Copper | 88.0-93.0 | weight percent |
| Tin | 2-3 | weight percent |
| Manganese | 5.0-9.0 | weight percent |
| Other elements | ≤10000 | weight ppm |

IV.

| | | |
|---|---|---|
| Copper | 61.0-69.0 | weight percent |
| Nickel | 8-12 | weight percent |
| Manganese | 23.0-27.0 | weight percent |
| Other elements | ≤10000 | weight ppm |

or

V.

| | | |
|---|---|---|
| Nickel | 70.0-78.0 | weight percent |
| Chronn | 18.0-22.0 | weight percent |
| Aluminium | 3-4 | weight percent |
| Silicon | 0.5-1.5 | weight percent |
| Manganese | 0.2-0.8 | weight percent |
| Iron | 0.2-0.8 | weight percent |
| Other elements | ≤10000 | weight ppm |

The powder of the resistance alloy can be produced by methods known to the person skilled in the art, such as gas nozzles under inert gas, water nozzles or grinding. The mean particle diameter d50 of the powder of the resistance alloy is preferably 0.2 μm-15 μm.

In addition to the powder of the resistance alloy, paste B contains an organic medium. In a preferred embodiment, paste B contains an organic medium in an amount of 2-40% by weight. The organic medium of paste B may contain at least one organic solvent and at least one binder. The organic solvent may be selected from the group consisting of texanol, terpineol, isotridecyl alcohol or other high-boiling organic solvents having a boiling point of at least 140° C. The binder may be selected from acrylate resins, ethyl celluloses or other polymers. Optionally, the organic medium of the paste B may contain further components which may be selected from the group consisting of thixotropic agents, stabilizers and emulsifiers. By adding these components, the printability or storage stability of the paste, for example, can be improved.

The optional glass frit of paste B contains at least two different elements as oxides. The elements can be selected from the group consisting of Li, Na, K, Ca, Mg, Sr, Ba, B, Al, Si, Sn, Pb, P, Sb, Bi, Te, La, Ti, Zr, V, Nb, Mn, Fe, Co, Ni, Cu, Ag, Zn, and Cd. The glass frit can be produced from oxides, fluorides or other salts (e.g. carbonates, nitrates, phosphates) of these elements. Examples of glass frit starting compounds may be selected from the group consisting of B2O3, H₃BO₃, Al₂O₃, SiO2, PbO, P₂O5, Pb₃O₄, PbF2, MgO, MnCO3, CaO, CaCO3, SrO, SrCO3, BaO, BaCO₃, Ba(NO₃)₂, Na₂B₄O₇, ZnO, ZnF₂, Bi₂O₃, Li₂O, Li₂CO₃, Na₂O, NaCO₃, NaF, K₂O, K₂CO₃, KF, TiO₂, Nb₂O₅, Fe₂O₃, ZrO₂ CuO, MnO, Mn₃O₄, MnO₂, CdO, SnO₂, TeO₂, Sb₂O₃, Co₃O₄, Co₂O₃, CoO, La₂O₃, Ag₂O, NiO, V₂O₅, Li₃PO₄, Na₃PO₄, K₃PO₄, Ca₃(PO₄)₂, Mg₃(PO₄)₂, Sr₃(PO₄)₂, Ba₃(PO₄)₂ and complex minerals such as colemanite and dolomite.

In a preferred embodiment the glass frit of paste B can contain silicon, aluminium, boron and at least one alkaline earth metal as oxide. The glass frit of the paste B can be the same as the glass frit of the paste A or different. The glass frit of paste B can contain at least two elements as oxides, which are contained in the glass frit of paste A. In a preferred embodiment, the glass frits of pastes A and B are the same, as this can improve the compatibility of layers A and B with each other.

In case the layer of paste A in step c) has already been burned to layer A, the layer of paste B is applied to layer A accordingly. By applying the paste B to the layer from step c), a precursor is produced. The precursor thus contains a substrate on which a layer of paste A is applied, which can optionally already be burned (then also called layer A). Furthermore, the precursor contains a layer of paste B on the layer of paste A, whereby the layer of paste B is not burned. In a preferred embodiment, the paste B is applied to a layer A which has already been burned in step c. In one embodiment, the precursor can be designed so that the layer of paste B completely covers the layer of paste A.

In step e), the precursor is burned and the layer structure according to the invention is obtained. Optionally, a drying step can be carried out prior to burning. Drying can take place at a temperature in the range of 20-180° C., particularly in the range of 120-180° C., e.g. in a drying tap or an infrared belt dryer.

The precursor is preferably burned at a temperature in the range of 700−1000° C., particularly in the range of 850-900° C. The precursor is preferably burned so that the components of the organic medium in the precursor volatilize and the powder of the resistance alloy and the glass frit are sintered together. Burning can take place either under atmospheric conditions in the presence of O₂ or under inert gas conditions (e.g. N₂ atmosphere). By burning the layer of paste A, layer A is obtained, as explained above, and by burning the layer of paste B, layer B is obtained. If the layer of paste A has not already been burned in step c), the layers of paste A and paste B are burned simultaneously by burning the precursor. If the layer of paste A has already been burned in step c), layer A will inevitably be burned again when the layer of paste B is burned.

The layer structure according to the invention, which exists after step e) contains:

a. a substrate with a glass or ceramic surface,

b. a layer A which at least partially covers the glass or ceramic surface of the substrate, wherein layer A comprises a glass in which at least two mutually different elements are contained as oxides and has a transformation temperature Tg in the range from 600 to 750° C.,

c. a layer B which at least partially covers layer A, wherein layer B comprises the following constituents:
I. a resistance alloy having a temperature coefficient of electrical resistance less than 150 ppm/K, and
II. optionally a glass containing at least two different elements as oxides, wherein layer B contains not more than 20% by weight of glass based on the total weight of layer B.

Layer A, which at least partially covers the glass or ceramic surface of the substrate, comprises the glass obtained by burning the glass frit from paste A. Typically, the glass in layer A contains sintered glass frit of paste A. Preferably, this glass frit is sintered homogeneously to the glass over the entire expansion of layer A and has no non-sintered areas.

In the layer structure, layer B has the resistance alloy of paste B and is mechanically firmly bonded to layer A. The mechanical strength of the adhesion can be determined by various tests. Layer B of the layer structure can have a TCR value that essentially corresponds to the bulk value of the resistance alloy.

The adhesive strength can be checked by the following tests: A strip of Scotch® Magic adhesive film (3M Deutschland GmbH) is stuck onto the burned layer structure and firmly applied with a fingernail, for example. The adhesive film is then removed again. Resistance alloy layers with low adhesion to the glass or ceramic surface of the substrate adhere to the adhesive film. Layer structures with a medium adhesive strength partly remain on the adhesive film and layer structures with a high adhesive strength are not detached from the adhesive film.

In the layer structure, layer A can act as an adhesion promoter between the glass or ceramic surface of the substrate and layer B containing the resistance alloy. This invention can thus be used to obtain a layer of a resistance alloy that is mechanically stably bonded to the substrate surface. The layer B contains the resistance alloy in the quantity originally used in paste B. The layer B contains the resistance alloy in the quantity originally used in paste B.

In the optional case that layer B additionally contains a glass made from the glass frit of paste B, the adhesion of layer B to layer A can be further improved. The glass content of layer B is determined by the amount of glass frit used in paste B. In a preferred embodiment, layer B does not contain more than 20% by weight of glass, in particular not more than 15% by weight of glass, based on the total weight of layer B.

Optionally, the layer structure can be provided with a sealant (also called protective glaze or overglaze) after step e). Typically, this sealing consists of a glass. This sealing serves in particular to protect the layer structure from environmental influences such as moisture.

The layer structure according to the invention can be used, among other things, to produce precision resistors.

### EXAMPLES

General Production of Paste A

Pastes A were prepared by mixing 22% by weight organic medium (85% by weight texanol, 15% by weight ethyl cellulose (75% N7, 25% N50)) and 78% by weight glass frit according to Table 1. The pastes were homogenized using a three-roll chair.

TABLE 1
Glasses used

| | Glas frit | Glas frit | Glas frit | Glas frit | Glas frit | Glas frit | Glas frit |
|---|---|---|---|---|---|---|---|
| | 1 | 2 | 3 | 4 | 5 | 6 | 7 |
| | Weight % | Weight % | Weight % | Weight % | Weight % | Weight % | Weight % |
| SiO2 | 43.0 | 50.0 | 48.0 | 16.8 | 43.0 | 57.0 | 42.0 |
| Al2O3 | 9.0 | 10.0 | 10.0 | | 9.0 | 12.0 | 18.0 |
| MgO | 3.0 | 2.0 | | | 3.0 | | |
| CaO | 6.0 | 10.0 | 8.0 | | 6.0 | 9.0 | 35.0 |
| SrO | 5.0 | | 22.0 | | 5.0 | | |
| BaO | 30.0 | 9.0 | 5.0 | 47.8 | 30.0 | | |
| Na2O | | | 1.0 | | | | |
| K2O | 2.0 | 4.0 | 2.0 | | 2.0 | 5.0 | |
| B2O3 | 2.0 | 15.0 | 4.0 | 35.5 | 2.0 | 17.0 | 5.0 |
| Sum | 100.0 | 100 | 100.0 | 100.0 | 100 | 100 | 100.0 |

General Production Pastes B

A powder of the resistance alloy isotane (mean particle diameter d50: 8 μm, produced by gas atomization of a melt under N2 atmosphere), an organic medium (65 wt. % texanol and 35 wt. % acrylate binder) and, if necessary, a glass frit were added in the specified quantities and homogenized by means of a three-roll chair. The produced pastes have a viscosity of about 30-90 Pas at 20-25° C.

TABLE 2

| weight % | Glas frit 7 | Isotan powder | Organic medium |
|---|---|---|---|
| Paste B1 | 6 | 84 | 10 |

Production of the Layer Structure

The glass pastes A, containing the glass frits from Table 1, were applied by screen printing to Al₂O₃ substrates with a size of 101.6×101.6 mm and a thickness of 0.63 mm (Rubalit 708 S, CeramTec). A screen from Koenen GmbH, Germany was used with an EKRA Microtronic II printer (type M2H). The emulsion thickness was about 50 μm (sieve parameters: 80 mesh and 65 μm wire diameter (stainless steel)). Printing parameters: 63 N doctor blade pressure, doctor blade speed 100 mm/s and a jump of 1.0 mm. The layer thickness after printing (wet) was about 90 μm. 10 minutes after printing, the samples were dried in an infrared belt dryer (BTU international, type HHG-2) for 20 min at 150° C. The drying time was about 10 minutes. The layer thickness after drying was about 60 μm. The printed glass layers were burned under nitrogen atmosphere (N2 5.0) in a furnace (ATV Technologie GmbH, type PEO 603). The temperature was increased from 25° C. to 850° C., kept at 850° C. for 10 and then cooled down to 25° C. within 20 min. The layer thickness after burning was about 50 μm. The resistance alloy paste B was applied to the previously produced layer by screen printing. A screen from Koenen GmbH, Germany was used with an EKRA Microtronic II printer (type M2H). The emulsion thickness was about 50 μm, sieve parameters: 80 mesh and 65 μm wire diameter (stainless steel).

The printed resistance alloy pastes (including the precursor) were burned in a nitrogen atmosphere (N2 5.0) in a furnace (ATV Technologie GmbH, type PEO 603). The temperature was increased from 25° C. to 900° C., kept at 900° C. for 10 min and cooled down to 25° C. within 20 min (total cycle time 82 min). The layer thickness after burning was about 50 μm.

### Example 1

TABLE 3
Adhesion tests with glass pastes (Paste A)
with different glass frits

| | | | | Adhesion Isotan |
|---|---|---|---|---|
| | | | | on Substrate |
| | | | | + = good; |
| Layer | | Glas frit | Isotan- | ∘ = moderate; |
| structure | Substrate | (Paste A) | Paste | − = bad |
| 1 | Al₂O₃ | 1 | Paste B1 | + |
| 2 | | 2 | (6% Glas 7) | + |
| 3 | | 3 | | + |
| 4 | | 4 | | + |
| 5 | | 5 | | + |
| 6 | | 6 | | + |
| 7 | | 7 | | + |
| 8 | | no Glas | | − |

### Example 2

Adhesion Layer Structure as a Function of the Amount of Glass in Paste B

TABLE 4
Resistance alloy pastes (paste B) with
different glass frit content

| | | Isotan | Organic |
|---|---|---|---|
| [weight %] | Glas frit 7 | powder | medium |
| Paste B2 | 0 | 90 | 10 |
| Paste B3 | 3 | 87 | 10 |
| Paste B4 | 6 | 84 | 10 |
| Paste B5 | 9 | 81 | 10 |

TABLE 5
Adhesion layer structure as a function of the amount
of glass in paste B before and after T-Shock Positioning

| | | | | Adhesion | Detachment |
|---|---|---|---|---|---|
| | | | | before T- | after |
| Layer | | Glas layer | Alloy layer | Shock | T-Shock |
| structure | Substrate | (layer A) | (layer B) | storage | storage |
| 9 | Al₂O₃ | Paste A | Paste B2 | good | 20 Cycles |
| 10 | | from glas 7 | Paste B3 | good | 100 Cycles |
| 11 | | | Paste B4 | good | >500 Cycles |
| 12 | | | Paste B5 | good | >500 Cycles |

T-Shock Storage:

The manufactured layer structures were each stored for 15 min in a chamber with a temperature of −40° C. or +150° C. The temperature of the storage chamber was −40° C. or +150° C. respectively. The transition from one chamber to the other was automated and took approx. 4 s. One cycle includes one storage at −40° C. and one at +150° C. The other cycle was automated. The adhesion was checked after different numbers of cycles with an adhesive tape as described above.

For layer structure 9 and layer structure 12, the TCR values were measured in the temperature range 20-60° C. according to the standard DIN EN 60115-1:2016-03 (drying method I):

TABLE 6

| Layer structure | Amount glas frit in paste B | TCR |
|---|---|---|
| 9 | 0 weight % | −25 bis −14 ppm/K |
| 12 | 9 weight % | −37 bis −21 ppm/K |

For comparison The TCR bulk value for isotane (as wire) is in the range of −80 to +40 ppm/K.

1. Method for producing a layer structure comprising the successive steps:
a. Providing a substrate having a glass or ceramic surface,
b. Applying a paste A to at least a portion of the glass or ceramic surface of the substrate to obtain a layer of paste A, wherein paste A contains the following constituents:
I. a glass frit containing at least two mutually different elements as oxides and having a transformation temperature Tg in the range of 600 to 750° C., and
II. an organic medium,
c. Drying and, if necessary, burning of the layer of paste A
d. Applying a paste B to at least part of the layer from step c. to obtain a layer of paste B, wherein paste B contains the following constituents:
I. A resistance alloy powder having an electrical resistance temperature coefficient of less than 150 ppm/K
II. an organic medium,
III. 0-15% by weight glass frit, based on the total weight of paste B, and
e. Burning and optional drying of the layers of paste B before burning.

2. Method according to claim 1, characterized in that paste B contains a glass frit which contains at least two mutually different elements as oxides.

3. Method according to any of claim 1 or 2, characterized in that paste B contains not more than 12 weight percent and preferably 5-12 weight percent glass frit based on the total weight of paste B.

4. Method according to any one of claims 1-3, wherein the resistance alloy of the paste B has a temperature coefficient of electrical resistance of less than 50 ppm/K.

5. Method according to any of claims 1-4, wherein the resistance alloy of the paste B is selected from the group consisting of:
Alloy I.
a. 53.0-57.0 weight percent copper,
b. 42.0-46.0 weight percent nickel,
c. 0.5-1.2 weight percent manganese and
d. Not more than 10000 ppm by weight of other elements.
Alloy II.
a. 83.0-89.0 weight percent of copper,
b. 10.0-14.0 weight percent manganese,
c. 1-3 weight percent nickel and
d. Not more than 10000 ppm by weight of other elements.
Alloy III.
a. 88.0-93.0 weight percent of copper,
b. 5.0-9.0 weight percent manganese,
c. 2-3 weight percent of tin and
d. Not more than 10000 ppm by weight of other elements.
Alloy IV.
a. 61.0-69.0 weight percent of copper,
b. 23.0-27.0 weight percent manganese,
c. 8-12 weight percent nickel; and
d. Not more than 10000 ppm by weight of other elements.
and
Alloy V.
a. 70.0-78.0 weight percent nickel,
b. 18.0-22.0 weight percent chromium,
c. 3-4 weight percent aluminium,
d. 0.5-1.5 weight percent silicon,
e. 0.2-0.8 weight percent manganese,
f. 0.2-0.8 weight percent iron,
g. Not more than 10000 ppm by weight of other elements.

6. Method according to any of claims 1-5, characterized in that paste A contains 50-90% by weight glass frit and 10-50% by weight organic medium based on the total weight of glass frit and organic medium.

7. Method according to any of claims 1-6, characterized in that the glass frits of paste A and/or paste B each contain silicon, boron, aluminum and an alkaline earth metal as oxide.

8. Method according to any of claims 1-7, characterized in that the glass frit of paste B contains at least two elements as oxides which are contained in the glass frit of paste A.

9. Method according to any of claims 1-8, characterized in that paste B comprises 60-95 weight percent of the resistance alloy, 3-15 weight percent of glass frit and 2-37 weight percent of organic medium, based on the total weight of paste B.

10. Layer structure comprising:
a. a substrate having a glass or ceramic surface,
b. a layer A at least partially covering the glass or ceramic surface of the substrate, wherein layer A comprises a glass in which at least two mutually different elements are contained as oxides and which has a transformation temperature Tg in the range of 600 to 750° C.,
c. a layer B which at least partially covers layer A, wherein layer B comprises the following constituents:
I. a resistance alloy having a temperature coefficient of electrical resistance less than 150 ppm/K, and
II. optionally a glass containing at least two different elements as oxides,
wherein layer B contains not more than 20 weight percent of glass based on the total weight of layer B.

11. Paste comprising
a. a powder of a resistance alloy having a temperature coefficient of electrical resistance of less than 150 ppm/K
b. a glass frit comprising silicon, boron, aluminum and an alkaline earth metal each as oxide,
c. an organic medium.

12. Paste according to claim 11, characterized in that the alkaline earth metal is calcium.

13. Paste according to one of claim 11 or 12, characterized in that the glass frit is prepared from
a. 25-55 weight percent silicon oxide,
b. 20-45 weight percent calcium carbonate,
c. 10-30 weight percent of aluminium oxide; and
d. 1-10 weight percent boron oxide.

14. Use of the layer structure according to claim 10 for the production of precision resistors.
